(19) United States
(12) Patent Application Publication
(10) Pub. No.: US 2019/0260561 A1
(43) Pub. Date: Aug. 22, 2019

(54) COMMUNICATION CONTROL DEVICE, WIRELESS COMMUNICATION DEVICE, METHOD AND PROGRAM

(71) Applicant: SONY CORPORATION, Tokyo (JP)

(72) Inventor: Sho FURUICHI, Tokyo (JP)

(73) Assignee: Sony Corporation, Tokyo (JP)

(21) Appl. No.: 16/308,843

(22) PCT Filed: May 30, 2017
(86) PCT No.: PCT/JP2017/020141

§ 371 Date: Dec. 11, 2018

(30) Foreign Application Priority Data
Jul. 27, 2016 (JP) 2016-147615

(51) Int. Cl. H04L 5/14; H04W 64/00; H04W 56/00; H04W 68/02

(52) U.S. Cl. CPC H04L 5/14; H04W 64/00; H04W 92/20; H04W 68/02; H04W 56/001

(57) ABSTRACT

A network management control device, a wireless communication device, a method and a program which are capable of realizing both coexistence control using information relating to a duplex mode and setup of an interface between wireless communication devices. The network management control device includes a a first information acquisition device to acquire information indicating a network to which one or more wireless communication devices belong, radio access technology information, information relating to an operable frequency band, information relating to a geographical location and/or region, information relating to a duplex mode, or information relating to a transmission time interval. There are also first and second notification devices. Additionally, there is a generation device to generate a list.

### TECHNICAL FIELD

The present disclosure relates to a communication control device, a wireless communication device, a device, a method and a program.

### BACKGROUND ART

As a countermeasure to alleviate shortage of future frequency resources, secondary usage of frequencies has been discussed. Secondary usage of frequencies means that part of or all of frequency channels allocated to a certain system with a higher priority is secondarily used by another system. Generally, a system to which a frequency channel is allocated with a higher priority is called “primary system”, and a system that secondarily uses the frequency channel is called “secondary system”.

TV whitespaces are an example of frequency channels that are expected to be secondarily used. TV whitespaces mean frequency channels that are allocated to a TV broadcast system serving as a primary system but are not locally used by the TV broadcast system. By allowing a secondary system to use those TV whitespaces, efficient utilization of frequency resources can be achieved. There are a plurality of standards for wireless access schemes in a physical layer (PHY) and MAC layer for enabling secondary usage of the TV whitespaces, such as IEEE802.22, IEEE802.1 laf, and European Computer Manufacturer Association (ECMA)-392 (CogNea).

In the U.S., activities for introducing a new frequency utilization form called citizens broadband radio service (CBRS) based on secondary usage of frequencies into 3550 to 3700 MHz bands on the basis of federal communications commission (FCC) rules, part 96 which is newly adopted are accelerated. It is assumed at the present moment that long term evolution (LTE) and MulteFire for which development has been promoted in recent years on the basis of LTE become the mainstream as a wireless access system operated in CBRS.

Concerning such secondary usage of frequencies, the following Patent Literature 1 discloses a management serve including a holding unit configured to hold a location/frequency list in which location information is associated with frequency information, a list creating unit configured to extract frequency information corresponding to location information from the location/frequency list on the basis of the location information to create an available frequency list, a transmitting unit configured to transmit the available frequency list to a base station which mainly uses the available frequency list, and a list comparing unit configured to compare the available frequency list transmitted to the base station and an available frequency list returned from the base station, and the list creating unit re-creating the available frequency list on the basis of information indicating a frequency being utilized by the base station among the available frequency list.

### CITATION LIST

### Patent Literature

Patent Literature 1: JP 5679033B

### DISCLOSURE OF INVENTION

### Technical Problem

However, a technology for secondary usage of frequencies proposed in the above-described Patent Literature 1, or the like, does not assume operation of a wireless system such as a cellular system typified by LTE, which is extensively developed over a wide range. While wireless parameters dynamically change in secondary usage of frequencies, for example, in the cellular system, wireless parameters set on the basis of network design concept, or the like, of each telecommunications carrier are used in a semi-fixed manner. Therefore, operation of the cellular system in secondary usage of frequencies can lead to, for example, increase in operation cost relating to tuning, or the like, of cells.

Therefore, to reduce operation cost relating to tuning, or the like, of cells, it can be considered that carriers introduce a self-organized network (SON). The SON not only self-organizes wireless parameters of an evolved node B (eNB), but also self-constructs an X2 interface with an eNB in the vicinity. It is necessary to make a notification of information relating to a frequency in signaling for self-constructing the X2 interface. In utilization of the SON in secondary usage of frequencies, because an eNB in the vicinity can dynamically change, it becomes necessary to know an eNB in the vicinity in advance. In this event, it is desirable that a signaling amount is suppressed to a minimum.

Further, in the existing SON, information relating to a duplex mode is not included in signaling for constructing the X2 interface. Particularly, in the case where the eNB is operated in TDD, if synchronization of frame configurations and transmission time intervals cannot be secured between adjacent eNBs, adjacent channel interference as well as co-channel interference can become a serious problem. In scenario of secondary usage of frequencies, networks of different carriers as well as networks of the same carrier need to coexist, and, in the case where coexistence control including change of the duplex mode is performed, it is desirable that means for notifying the adjacent eNB of information relating to the duplex mode beyond frameworks of carriers is provided.

In cellular systems of 5G and subsequent generations as well as LTE, a managed Wi-Fi system, or the like, it can be considered that a similar problem may occur if a mechanism similar to that of the SON is employed.

Therefore, the present disclosure proposes a newly improved network management control device, wireless communication device, method and program which are capable of appropriately utilizing an SON in secondary usage of frequencies.

### Solution to Problem

According to the present disclosure, there is provided a network management control device including: a first information acquisition unit configured to acquire information indicating a network to which one or more wireless communication devices belong, radio access technology information, information relating to an operable frequency band, information relating to a geographical location and/or region, information relating to a duplex mode, or information relating to a transmission time interval; a first notification unit configured to notify a communication control device of the information; a second information acquisition unit configured to acquire a recommended operation parameter selected on the basis of the information; a generation unit configured to generate a list including information of a wireless communication device which has a possibility of being located in a vicinity of the wireless communication device, by using the recommended operation parameter acquired by the second information acquisition unit; and a second notification unit configured to notify the wireless communication device of the list and the recommended operation parameter.

In addition, according to the present disclosure, there is provided a wireless communication device including: a first notification unit configured to notify a network management control device of information indicating a network, radio access technology information, information relating to an operable frequency band, information relating to a geographical location and/or region, information relating to a duplex mode, or information relating to a transmission time interval; an information acquisition unit configured to acquire a recommended operation parameter and a list including information of a wireless communication device which has a possibility of being located in a vicinity, from the network management control device; a self-organizing unit configured to self-organize a wireless parameter on the basis of the recommended operation parameter acquired by the information acquisition unit; an information processing unit configured to extract a wireless communication device which is located in a vicinity from the list acquired by the information acquisition unit by using the wireless parameter organized by the self-organizing unit; and a second notification unit configured to perform signaling for constructing an interface with the wireless communication device which is located in the vicinity and which has been extracted by the information processing unit.

In addition, according to the present disclosure, there is provided a program for causing a computer to operate as: a first information acquisition unit configured to acquire information indicating a network to which one or more wireless communication devices belong, radio access technology information, information relating to an operable frequency band, information relating to a geographical location and/or region, information relating to a duplex mode, or information relating to a transmission time interval, a first notification unit configured to notify a communication control device of the information; a second information acquisition unit configured to acquire a recommended operation parameter selected on the basis of the information; a generation unit configured to generate a list including information of a wireless communication device which has a possibility of being located in a vicinity of the wireless connmunication device, by using the recommended operation parameter acquired by the second information acquisition unit; and a second notification unit configured to notify the wireless communication device of the list and the recomnnended operation parameter.

In addition, according to the present disclosure, there is provided a program for causing a computer to operate as: a first notification unit configured to notify a network management control device of information indicating a network, radio access technology information, information relating to an operable frequency band, information relating to a geographical location and/or region, information relating to a duplex mode, or information relating to a transmission time interval; an information acquisition unit configured to acquire a recommended operation parameter and a list including information of a wireless communication device which has a possibility of being located in a vicinity, from the network management control device; a self-organizing unit configured to self-organize a wireless parameter on the basis of the recommended operation parameter acquired by the information acquisition unit; an information processing unit configured to extract a wireless communication device which is located in a vicinity from the list acquired by the information acquisition unit, by using the wireless parameter organized by the self-organizing unit; and a communication unit configured to perform signaling for constructing an interface with the wireless communication device which is located in the vicinity and which has been extracted by the information processing unit.

In addition, according to the present disclosure, there is provided a method including: acquiring information indicating a network to which one or more wireless communication devices belong, radio access technology information, information relating to an operable frequency band, information relating to a geographical location and/or region, information relating to a duplex mode, or information relating to a transmission time interval; notifying a communication control device of the information; acquiring a recommended operation parameter selected on the basis of the information; generating a list including information of a wireless communication device which has a possibility of being located in a vicinity of the wireless communication device, by using the recommended operation parameter acquired by the second information acquisition unit; and notifying the wireless communication device of the list and the recomnnended operation parameter.

In addition, according to the present disclosure, there is provided a method including: notifying a network management control device of information indicating a network, radio access technology information, information relating to an operable frequency band, information relating to a geographical location and/or region, information relating to a duplex mode, or information relating to a transmission time interval; acquiring a recommended operation parameter and a list including information of a wireless communication device which has a possibility of being located in a vicinity, from the network management control device; self-organizing a wireless parameter on the basis of the recommended operation parameter; extracting a wireless communication device which is located in a vicinity from the list, by using the wireless parameter used in the self-organization; and performing signaling for constructing an interface with the extracted wireless communication device which is located in the vicinity.

### Advantageous Effects of Invention

As described above, according to the present disclosure, it is possible to appropriately utilize an SON in secondary usage of frequencies. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram for explaining outline of a communication system according to an embodiment of the present disclosure.

FIG. 2 is a diagram for explaining an architecture according to the present embodiment.

FIG. 3 is a block diagram illustrating an example of a configuration of a communication control device according to the present embodiment.

FIG. 4 is a block diagram illustrating an example of a configuration of a network management control device 20 according to the present embodiment.

FIG. 5 is a block diagram illustrating an example of a configuration of a wireless communication device 30 according to the present embodiment.

FIG. 6 is a diagram for explaining an example of procedure in which the wireless communication device notifies the network management control device of information necessary for communication control according to the present embodiment.

FIG. 7 is a diagram for explaining an example of procedure in which the network management control device notifies the wireless communication device of information relating to operation according to the present embodiment.

FIG. 8 is a diagram for explaining an example of procedure performed by the wireless communication device to construct an interface with a wireless communication device according to the present embodiment.

### MODE(S) FOR CARRYING OUT THE INVENTION

Hereinafter, a preferred embodiment of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, in the present specification and drawings, elements that have substantially the same function and structure are distinguished in some cases by adding different alphabets after the same reference numerals. For example, a plurality of elements that have substantially the same function and structure are distinguished like wireless communication devices 30A and 30B according to necessity. However, in a case where it is not particularly necessary to distinguish among a plurality of elements that have substantially the same function and structure, the same reference numerals are merely given. For example, in the case where it is not particularly necessary to distinguish among the wireless communication devices 30A and 30B, they are simply referred to as a wireless communication device 30.

Note that description will be provided in the following order.

### 1. Outline

1.1. Overall system configuration
1.2. Technical problems
2. Detailed description of the invention

### 2.1. Architecture

2.2. Configuration example of network management control device
2.3. Technical features of network management control device
2.4. Configuration example of wireless communication device
2.5. Technical features of wireless communication device

### 2.5. Procedure

### 3. Conclusion

### 1. OUTLINE

### 1.1. Overall System Configuration

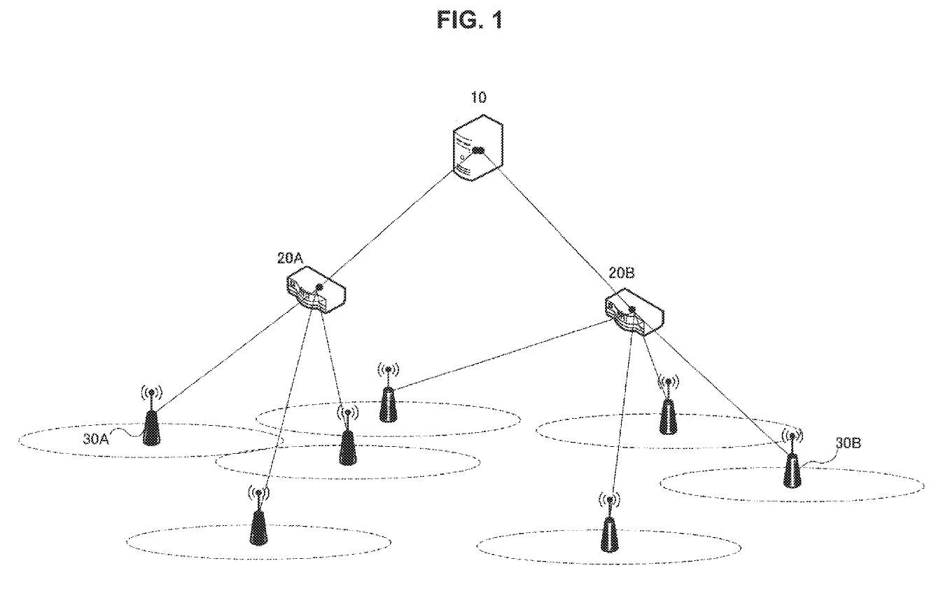

FIG. 1 is an explanatory diagram for explaining outline of a communication system according to an embodiment of the present disclosure.

Referring to FIG. 1, a plurality of wireless communication devices 30A operated by a first telecommunications carrier A, and a plurality of wireless communication devices 30B operated by a second telecommunications carrier B are illustrated. As illustrated in FIG. 1, the wireless communication device 30 is typically a base station, or a transmitting station such as an access point. The wireless communication device 30A which is a transmitting station provides service of the telecommunications carrier A to a receiving station located inside a service area. The wireless communication device 30B which is a transmitting station also provides service of the telecommunications carrier B to a receiving station located inside a service area in a similar manner.

The wireless communication devices 30A and 30B are respectively connected to network management devices 20A and 20B. The network management device 20 is a device introduced by a telecommunications carrier to manage and control the plurality of wireless communication devices 30.

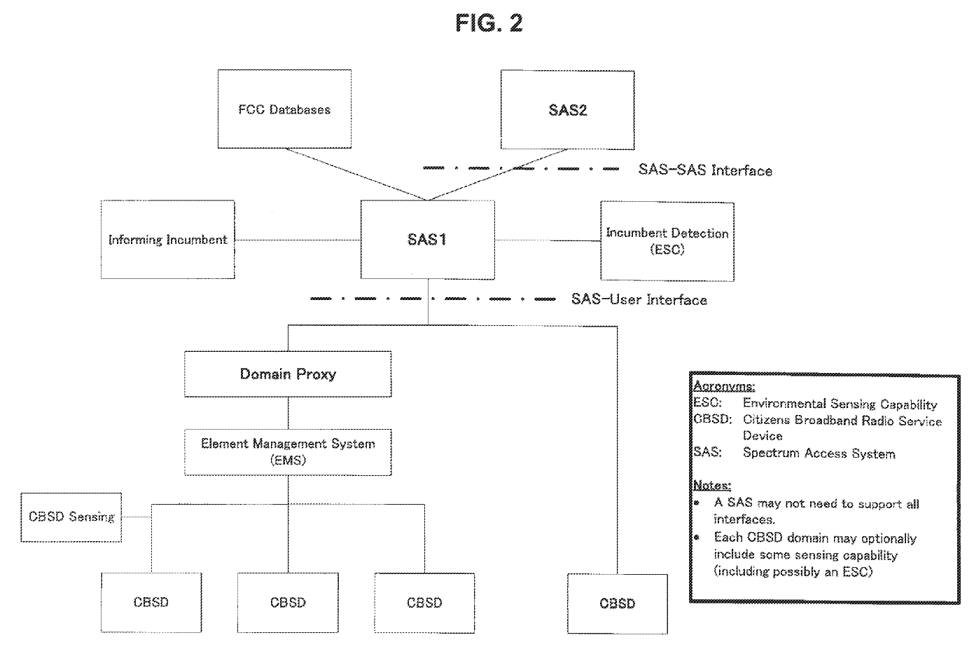

Note that, in LTE, for example, the network management device 20 may be a device called an element management system (EMS) or a domain manager (DM). Alternatively, the network management device 20 may be entity called domain proxy (DP) included in an architecture standardized in a wireless innovation forum (WInnF) illustrated in FIG. 2. Alternatively, a management device which integrally provides the EMS, the DM and the DP or an aggregate of these may be handled as the network management device.

The network management devices 20A and 20B are connected to a communication control device 10. The communication control device 10 provides permission of secondary usage of frequency channels allocated to a primary system to the wireless communication device 30 within a range not providing fatal interference to the primary system. Specifically, the communication control device 10 has a function of notifying each of the wireless communication devices of a list of available frequencies and/or transmission power, or a function of determining whether or not a frequency and/or transmission power which the wireless communication device 30 desires to use can be used and notifying each of the wireless communication devices of the determination result, and typically, protects the primary system. The network management device 20 mediates communication between the plurality of subordinate wireless communication devices 30 and the communication control device 10 and/or assists re-configuration of wireless parameters of the wireless communication devices 30 on the basis of information obtained from the communication control device 10.

Note that examples of the primary system encompass TV broadcast systems, program making and special events (PMSE), radars (military radar, ship-based radar, weather radar, or the like), fixed satellite services (FSS), mobile satellite services (MSS), earth exploration satellite services (EESS), and the like.

Further, the communication control device 10 performs control and judgment so that each of the plurality of wireless communication devices 30 can operate without providing fatal interference to other wireless communication devices 30. Typically, the communication control device 10 performs coexistence management.

Here, there is a case where service areas of a plurality of telecommunications carriers geographically overlap with each other, and frequency bands used overlap with each other. As a specific example, for example, there can be a case where an area where long term evolution (LTE) service is provided and an area where Wi-Fi service is provided overlap with each other, the LTE service and the Wi-Fi service being operated by different telecommunications carriers. Alternatively, for example, there can be a case where an area where long term evolution (LTE) service is provided and an area where 5G and/or further advanced service is provided overlap with each other, although the LTE service and the 5G and/or further advanced service being operated by the same telecommunications carrier. Alternatively, for example, there can be a case where an area where wireless communication service (such as LTE and 5G) operated by a telecommunications carrier is provided and an area where a wireless communication device which is personally operated is operated overlap with each other.

In the present embodiment, it is assumed that part or all of frequency bands allocated to the primary system are secondary used by one or more wireless communication devices in cooperation with each other under such circumstances. To realize this, it is desirable that, in scenario of secondary usage of frequencies by a cellular system, appropriate information for coexistence is exchanged between different telecommunications carriers and between different wireless communication devices.

### 1.2. Technical Problems

There are the following concerns in secondary usage of frequencies by the cellular system.

### (1) Synchronization Between Wireless Communication Devices

It is assumed that the wireless communication devices are operated in TDD. In a case of LTE, wireless frame configurations having different combination of uplink and downlink are specified, and to reduce interference, it is necessary to set the same combination between wireless communication devices. Further, it is also necessary to achieve temporal synchronization.

### (2) Signaling Relating to Construction of X2 Interface Using SON

It is considered to introduce the SON to reduce operation cost in association with change of operation parameters of a number of wireless communication devices upon secondary usage of frequencies by the cellular system. In the SON, signaling is performed between the wireless communication devices to construct an interface (e.g. an LTE X2 interface) to be utilized for controlling interference, or the like, between the wireless communication devices. To perform signaling, while it is necessary to know which wireless communication device is located in the vicinity, in the scenario of secondary usage of frequencies, a wireless communication device which should be taken into account as a wireless communication device located in the vicinity can dynamically change in association with change of an operating frequency.

Further, while it is considered that interference can be appropriately controlled by wireless frame configurations being made the same upon TDD operation, this information is not included in signaling for constructing the X2 interface. In the case where coexistence control in which the wireless frame configurations are also taken into account is performed, because the wireless frame configurations can also dynamically change, it is desirable that information is appropriately exchanged.

Therefore, in view of the above-described circumstances, the invention according to the embodiment of the present disclosure has been achieved. In secondary usage of frequencies so far, there has not been provided a mechanism for coexistence which is focused on usage of the SON and a duplex mode of the wireless communication device. Therefore, in the present embodiment, a mechanism of utilizing information relating to the wireless communication device located in the vicinity and information relating to the duplex mode is provided. By this means, it becomes possible to realize appropriate secondary usage of frequencies in the cellular system which uses the SON.

### 2. FIRST EMBODIMENT

### 2.1. Architecture

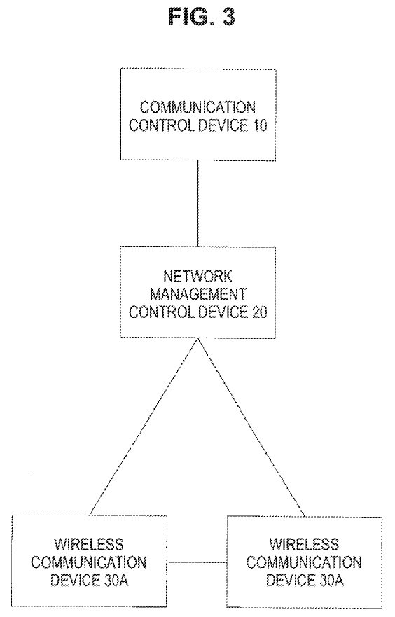

FIG. 3 is a diagram for explaining an architecture according to the present embodiment.

### 2.2. Configuration Example of Network Management Control Device

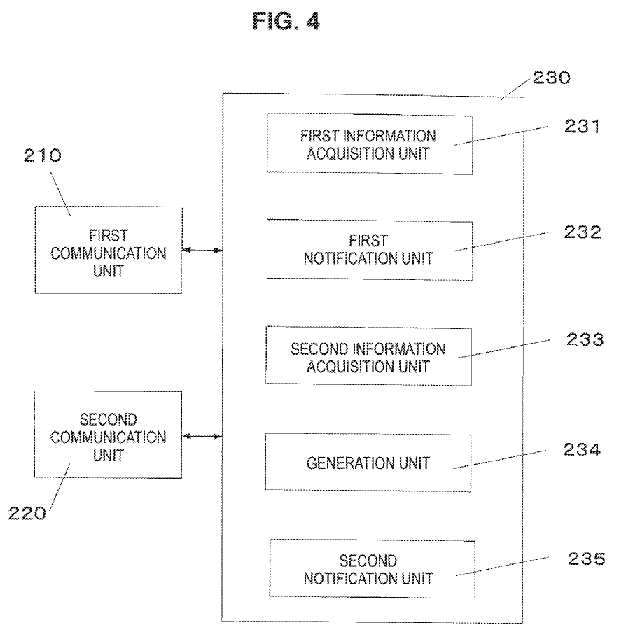

A configuration example of a network management control device will be described below with reference to FIG. 4.

FIG. 4 is a block diagram illustrating an example of a configuration of a network management control device 20 according to the present embodiment. As illustrated in FIG. 4, the network management control device 20 includes a first communication unit 210, a second communication unit 220 and a processing unit 230. Further, the processing unit 230 includes a first information acquisition unit 231, a first notification unit 232, a second information acquisition unit 233, a generation unit 234 and a second notification unit 235.

The first communication unit 210 is a communication interface which mediates communication with the communication control device 10. The first communication unit 210 supports arbitrary wireless communication protocol or wired communication protocol and establishes communication connection with the communication control device 10.

The second communication unit 220 is a communication interface which mediates communication with the wireless communication device 30. The second communication unit 220 supports arbitrary wireless communication protocol or wired communication protocol and establishes communication connection with the wireless communication device 30.

The processing unit 230 provides various functions of the network management control device 20. The processing unit 230 includes the first information acquisition unit 231, the first notification unit 232, the second information acquisition unit 233, the generation unit 234 and the second notification unit 235. Note that the processing unit 230 can further include structural elements other than these structural elements. That is, the processing unit 230 can perform operation other than operation of these structural elements. The functions of the processing unit 230 will be described in detail later.

### 2.3. Technical Features of Network Management Control Device

### (1) First Information Acquisition Function

The first information acquisition unit 231 acquires information relating to one or more wireless communication devices 30. The first information acquisition unit 231 acquires at least information indicating a network to which the wireless communication device belongs, radio access technology information, information relating to an operable frequency band, information relating to a geographical location and/or region, information relating to a duplex mode or information relating to a transmission time interval.

Note that part or all of the information may be directly acquired from the wireless communication device 30. Alternatively, in the case where part or all of the information is managed at an information management device which belongs to an external network or an intra-network, the part or all of the information may be acquired from the information management device.

The information indicating a network to which the wireless communication device belongs is typically an identifier indicating a telecommunications carrier. A mobile network code (MNC), a public land mobile network (PLMN) ID, or the like, can be assumed. In the case where the telecommunications carrier further groups the wireless communication devices, an identifier indicating a group to which the wireless communication device belongs may be included. Further, in the case where one or more network management devices 20 are provided by one telecommunications carrier, an identifier for identifying the network management device may be included. In the case where the wireless communication device is a RAT which provides an autonomous distributed network such as Wi-Fi, the information may be an identifier indicating a local network such as an SSID.

The radio access technology information is typically an identifier indicating a RAT provided at the wireless communication device. The radio access technology information may include an identifier of the RAT which can be changed by the wireless communication device as well as an identifier of a RAT which is being operated. Further, an operation parameter which is unique to a RAT, which can contribute to judgement of coexistence control, such as Transmission Mode defined in LTE may be included.

The information relating to the operable frequency band is typically a frequency band at which the wireless communication device can operate with a hardware configuration thereof. For example, a beginning frequency and an end frequency may be provided. Alternatively, for example, the number of a band specified in the 3rd generation partnership project (3GPP) may be provided. Alternatively, for example, in the case where a channel number is allocated as in a TV frequency band, the channel number may be provided. Alternatively, for example, the operable frequency band may be provided using combination of a center frequency and a bandwidth. Whichever information is provided, in the case where the wireless communication device can operate in a plurality of frequency bands, a plurality of pieces of the information relating to the operable frequency bands may be provided.

The information relating to the location is typically information which can specify a geographically location and/or region of the wireless communication device. For example, the information may be coordinate information acquired by the wireless communication device including a positioning function typified by a global navigation satellite system (GNSS). Typically, information relating to longitude, latitude, altitude and a positioning error can be included. Alternatively, for example, the information may be location information registered in an information management device managed by national regulatory authority (NRA) or entrusted institution thereof. Further, for example, as the information indicating the geographical region, information such as census tract, area name, prefecture name, state name, town name, block number, and address can be included as information which is administratively defined. Alternatively, for example, the geographical region may be expressed with combination of three or more pieces of coordinate information. Alternatively, for example, the geographical region may be expressed with combination of coordinate information and radius information.

The information relating to the duplex mode includes at least an identifier indicating a duplex mode which is being operated at the wireless communication device. The information can include an identifier indicating frequency division duplex (FDD), time division duplex (TDD), supplemental downlink (SDL), full duplex, or the like. In the case where the identifier indicates TDD, further, the information includes an identifier indicating a configuration which is being operated among TDD frame configurations indicated in the following Table 1.

TABLE 1

| | Switch- | | | | | | | | | | | |
|---|---|---|---|---|---|---|---|---|---|---|---|---|
| Config- | point | | Subframe number | | | | | | | | | |
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

The above-described Table 1 indicates configurations in 3GPP TS 36.300.

The information relating to the transmission time is typically a transmission time interval (TTI). Further, if the TTI is variable, the information may include a TTI value which can be changed by the wireless communication device.

### (2) First Notification Function

The first notification unit 232 typically has a function of generating a message based on the information acquired at the first information acquisition unit and transmitting the message to the first communication unit. Specifically, the message can include the information indicating the network to which the wireless communication device belongs, the radio access technology information, the information relating to the operable frequency band, the information relating to the geographical location and/or region, the information relating to the duplex mode or the information relating to the transmission time interval concerning one or more wireless communication devices.

### (3) Second Information Acquisition Function

The second information acquisition unit 233 acquires information relating to operation of one or more wireless communication devices 30. Typically, the second information acquisition unit 233 acquires recommended operation parameters. For example, the information can include one or more pieces of information among information relating to a recommended radio access technology, information relating to a recommend frequency band, information relating to a recommended duplex mode or a recommended transmission time interval.

The recommended radio access technology information is typically an identifier indicating a RAT which is recommended to be operated and/or an operation parameter which is unique to the RAT. The operation parameter which is unique to the RAT is, for example, Transmission Mode specified in LTE.

As the information relating to the recommended frequency band, for example, a beginning frequency band and an end frequency band at which operation is recommended are provided. Alternatively, for example, the number of a band specified in the 3rd generation partnership project (3GPP) may be provided. Alternatively, for example, in the case where a channel number is allocated as in a TV frequency band, the channel number may be provided. Alternatively, for example, the recommended frequency band may be provided using combination of a center frequency and a bandwidth. Whichever information is provided, in the case where operation is recomnnended in a plurality of frequency bands, a plurality of pieces of information relating to the recommended frequency bands may be provided.

The information relating to the recommended duplex mode includes at least an identifier indicating a duplex mode in which operation is recommended. The information can include an identifier indicating frequency division duplex (FDD), time division duplex (TDD), supplemental downlink (SDL), full duplex, or the like. In the case where the identifier indicates TDD, further, the information includes an identifier indicating a configuration which is being operated among the TDD frame configurations indicated in the above-described Table 1.

The recommended transmission time interval is typically a transmission time interval (TTI).

### (4) Generation Function

The generation unit 234 has a function of generating information relating to operation of one or more wireless communication devices 30. Typically, the generation unit 234 generates a list including information of the wireless communication devices which can be located in the vicinity of the wireless communication device 30 using the recommended operation parameters acquired at the second information acquisition unit 233.

For example, in the case where part or all of candidates for an operating frequency band recommended for the wireless communication device 30A is included in the recommended operating frequency band of the wireless communication device 30B, the wireless communication device 30B may be included in the list.

Alternatively, for example, the wireless communication device 30B for which a radio access technology which is the same as the radio access technology recommended for the wireless communication device 30A may be included in the list.

Alternatively, for example, in the case where there are a plurality of candidates for each of the recommended operation parameters acquired at the second information acquisition unit 133, the generation unit 234 may select one or more candidates. In this case, one or more pieces of information of the information relating to the recommended radio access technology, the information relating to the recommended frequency band, the information relating to the recommended duplex mode or the recommended transmission time interval can be included.

For example, in the case where there are a plurality of candidates for the recommended operation parameters, the same parameters may be selected among the wireless communication devices so that a plurality of arbitrary wireless communication devices are likely to be located in the vicinity.

For example, parameters may be selected so that the TTI and the TDD frame configurations become the same among the plurality of wireless communication devices. By this means, it becomes possible to secure synchronization, so that it is possible to reduce co-channel interference and adjacent channel interference.

### (5) Second Notification Function

The second notification unit typically has a function of generating a message using information relating to operation of one or more wireless communication devices 30, generated at the generation unit 234 and transmitting the message to the second communication unit.

### 2.4. Configuration Example of Wireless Communication Device

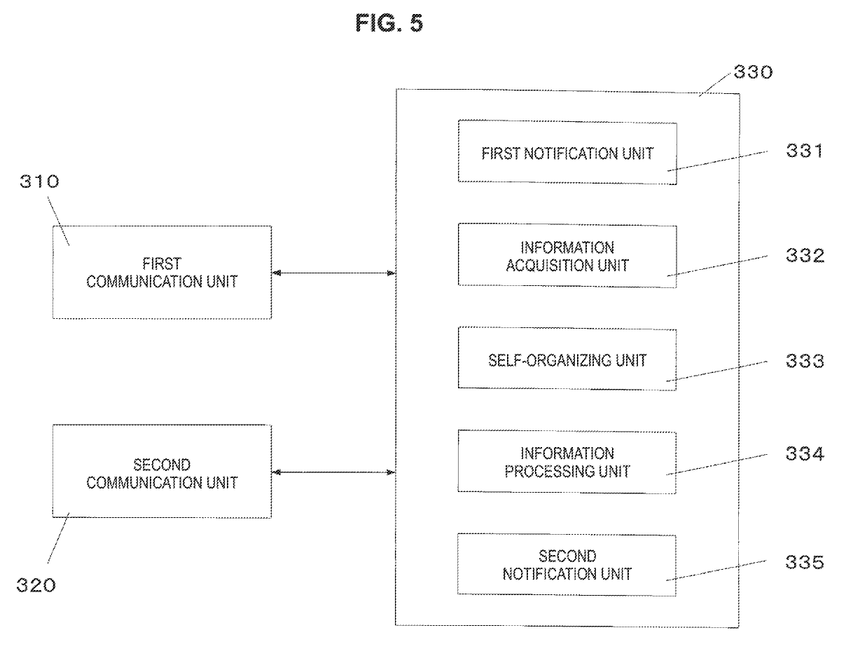

A configuration example of the wireless communication device will be described below with reference to FIG. 5.

FIG. 5 is a block diagram illustrating an example of a configuration of the wireless communication device 30 according to the present embodiment. As illustrated in FIG. 3, the wireless communication device 30 includes a first communication unit 310, a second communication unit 320 and a processing unit 330.

The first communication unit 310 is a communication interface which mediates communication with the network management device 20. The communication unit 310 supports arbitrary wireless communication protocol or wired communication protocol and establishes communication connection with the network management device 20.

The second communication unit 320 is a communication interface which mediates communication with other wireless communication devices 30. The communication unit 320 supports arbitrary wireless communication protocol or wired communication protocol and establishes other wireless communication devices 30.

The processing unit 330 provides various functions of the wireless communication device 30. The processing unit 330 includes a first notification unit 331, an information acquisition unit 332, a self-organizing unit 333, an information processing unit 334 and a second notification unit 335. Note that the processing unit 330 can further include structural elements other than these structural elements. That is, the processing unit 330 can perform operation other than operation of these structural elements. The functions of the processing unit 330 will be described in detail later.

### 2.5. Technical Features of Wireless Communication Device

### (1) First Notification Function

The first notification unit 331 has a function of transmitting a message including information necessary for communication control to the network management control device 20. The information necessary for communication control includes at least information indicating a network to which the wireless communication device belongs, radio access technology information which is being operated, information relating to an operable frequency band, information relating to a duplex mode and information relating to a transmission time interval.

Further, in the case where it is necessary to notify the network management control device 20 of information relating to a location which can be acquired by a positioning function, the information relating to the location is included in the message.

### (2) Information Acquisition Function

The information acquisition unit 332 typically has a function of acquiring information relating to operation from the network management control device 20. Specifically, for example, the information acquisition unit 332 acquires the recommended operation parameters selected on the basis of the information notified via the first notification unit 331. One or more pieces of information of recommended radio access technology information, information relating to a recommended frequency band, information relating to a recommended duplex mode or information relating to a recommended transmission time interval can be included.

Further, for example, the information acquisition unit 332 acquires a list including information of the wireless communication devices which can be located in the vicinity. The list can include connection information such as IP addresses, recommended operation parameters and/or current operation parameters concerning one or more other wireless communication devices.

### (3) Self-Organization Function

The self-organizing unit 333 has a function of setting operation parameters relating to wireless communication. This function is implemented on the basis of the recommended operation parameters acquired at the information acquisition unit 332. One or more of setting of a radio access technology, setting of a frequency band, setting of a duplex mode or setting of a transmission time interval is performed.

### (4) Information Processing Function

The information processing unit 334 typically extracts a wireless communication device located in the vicinity on the basis of the list including the operation parameters set at the self-organizing unit 333 and information of the wireless communication devices which can be located in the vicinity, acquired at the information acquisition unit 332. A wireless communication device 30 which utilizes at least the same radio access technology and the same operating frequency band is extracted as the wireless communication device located in the vicinity.

### (5) Second Notification Function

The second notification unit 335 has a function of generating a message for constructing an interface to the wireless communication device located in the vicinity, extracted at the information processing unit 334 and transmitting the message to the second communication unit. The message includes at least the radio access technology information, the operating frequency band, the information relating to the duplex mode and the transmission time interval of the wireless communication device 30.

The radio access technology information is typically an identifier indicating a RAT and/or an operation parameter which is unique to the RAT. The operation parameter which is unique to the RAT is, for example, Transmission Mode specified in LTE.

As the information relating to the operating frequency band, for example, a beginning frequency and an end frequency at which operation is being performed are provided. Alternatively, for example, the number of a band specified in the 3rd generation partnership project (3GPP) may be provided. Alternatively, for example, in the case where channel numbers are allocated as in TV frequency bands, a channel number may be provided. Alternatively, for example, a frequency band may be provided using combination of a center frequency and a bandwidth. Whichever information is provided, in the case where operation is performed in a plurality of frequencies, a plurality of pieces of information relating to the frequency bands may be provided.

The information relating to the duplex mode includes at least an identifier indicating a duplex mode in which operation is being performed. The information can include an identifier indicating frequency division duplex (FDD), time division duplex (TDD), supplemental downlink (SDL), full duplex, or the like. In the case where the identifier indicates TDD, the information further includes an identifier indicating a configuration which is being operated among the TDD frame configurations indicated in the above-described Table 1.

As the transmission time interval, typically, a value of a transmission time interval (TIT) is provided.

### 2.6. Procedure

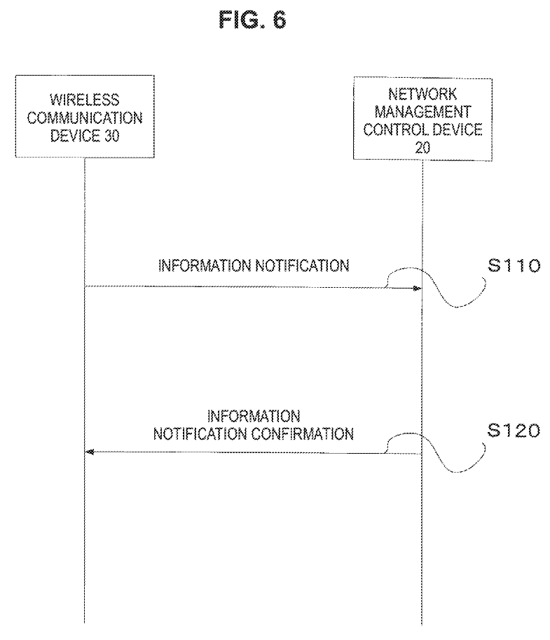

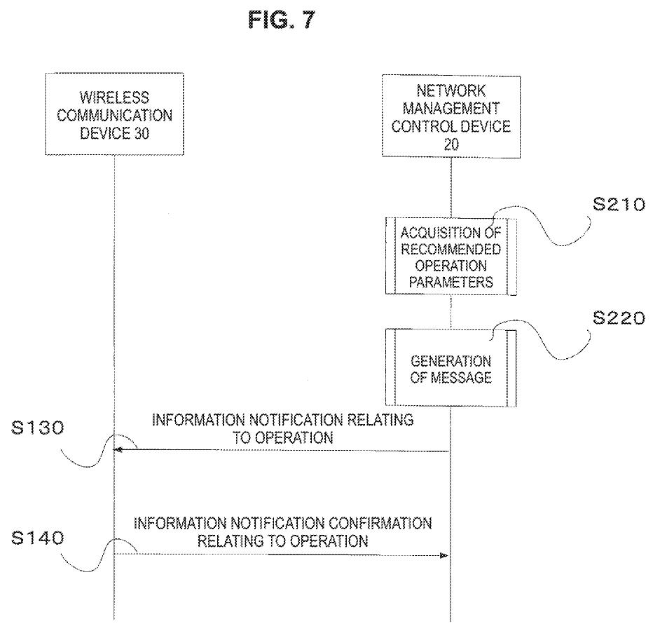

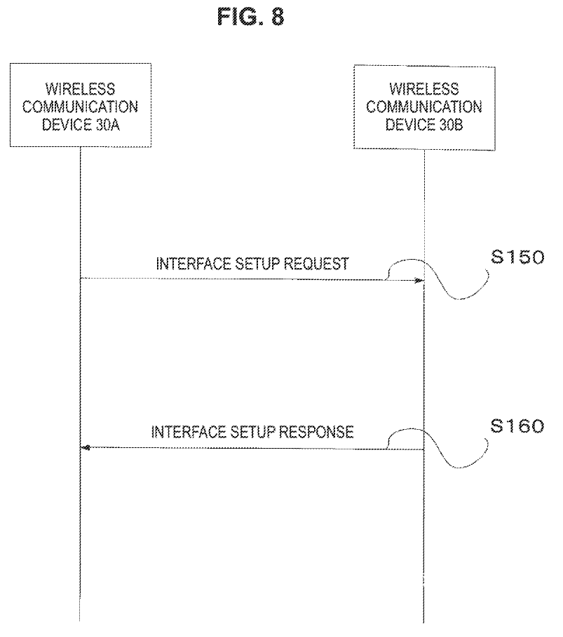

An example of procedure performed in association with introduction of the network management control device 20 and the wireless communication device 30 will be described below with reference to FIG. 6, FIG. 7 and FIG. 8.

The procedure illustrated in FIG. 6 is procedure in which the wireless communication device 30 notifies the network management control device 20 of information necessary for communication control. Information notification (S110) and information notification confirmation (S120) are performed.

The information notification (S110) includes at least information indicating a network to which the wireless communication device belongs, radio access technology information which is being operated, information relating to an operable frequency band, information relating to a duplex mode, and information relating to a transmission time interval. Further, in the case where location information is not managed by the NRA or entrusted institution thereof, and it is necessary to acquire the location information using a positioning function provided at the wireless communication device 30 and notify the communication control device 10 of the location information, the message includes the location information.

The information notification confirmation (S130) can include at least information indicating a message receipt status. For example, the information notification confirmation includes at least a status code. In the case where the status code indicates one other than SUCCESS, the information notification confirmation may include a message indicating error content.

The procedure illustrated in FIG. 7 is procedure in which the network management control device 20 notifies the wireless communication device 30 of information relating to operation. Acquisition of recommended operation parameters (S210), generation of a message (S220), information notification relating to operation (S130) and information notification confirmation relating to operation (S140) are performed.

In the acquisition of recommended operation parameters (S210), recommended operation parameters are acquired by the network management control device 20. Typically, the recommended operation parameters are acquired from the communication control device 10. Alternatively, the network management control device 20 may further select the recommended operation parameters using the recommended operation parameters acquired from the communication control device 10. Alternatively, by being triggered by completion of the procedure illustrated in FIG. 6, the recommended operation parameters may be selected on the initiative of the network management control device 20 using the information acquired through the procedure illustrated in FIG. 6.

In the generation of the message (S220), typically, a message including the information acquired at the acquisition of the recommended operation parameters (S210) is generated.

The information notification relating to operation (130) includes at least the message generated at the generation of the message (S220).

The information notification confirmation relating to operation (S140) can include at least information indicating a message receipt status. For example, the information notification confirmation relating to operation includes at least a status code. In the case where the status code indicates one other than SUCCESS, the information notification confirmation relating to operation may include a message indicating error content.

The procedure illustrated in FIG. 8 is procedure performed by the wireless communication device 30A to construct an interface with the wireless communication device 30B. Interface setup request (S150), and interface setup response (S160) are included.

The interface setup request (S150) includes at least information relating to an operating frequency band, information relating to a duplex mode, and information relating to a transmission time interval. For example, in the case where the wireless communication device 30 is an eNB of LTE, X2 interface setup request defined in standards of the SON, the information relating to the duplex mode, and the information relating to the transmission time interval may be included.

The interface setup response (S160) can include at least information indicating a message receipt status. For example, the interface setup response includes at least a status code. In the case where the status code indicates one other than SUCCESS, the interface setup response may include a message indicating error content.

### 4. CONCLUSION

An embodiment of the present disclosure has been described above in detail with reference to FIG. 1 to FIG. 8. As described above, the network management control device according to the present embodiment can acquire information indicating a network to which the wireless communication device managed by the network management control device belongs, the radio access technology information, the information relating to the operable frequency band, the location information, the information relating to the duplex mode, and the information relating to the transmission time interval. By this means, it becomes possible to generate a list of wireless communication devices located in the vicinity of each of the wireless communication devices, so that it becomes possible to construct an interface between the wireless communication devices even when the operation parameters are changed. Further, it becomes possible to exchange the information relating to the duplex mode and the information relating to the transmission time interval between different wireless communication devices, so that synchronization is secured, and it becomes possible to reduce co-channel interference and adjacent channel interference.

The preferred embodiment of the present disclosure has been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, it is also possible to create a computer program for causing a processor (such as, for example, a CPU and a DSP) provided at the device in the present specification (for example, a base station, a base station device or a module for the base station device, a terminal device or a module for the terminal device) to function as structural elements (such as, for example, the processing unit 130) of the above-described device (in other words, a computer program for causing the above-described processor to execute operation of structural elements of the above-described device). Further, it is also possible to provide a recording medium in which the computer program is recorded. Further, it is also possible to provide a device including a memory in which the above-described computer program is stored and one or more processors which can execute the above-described computer program (for example, a base station, a base station device or a module for the base station device, a terminal device or a module for the terminal device). Further, a method including operation of the structural elements (such as, for example, the processing unit 130) of the above-described device is included in the technology according to the present disclosure.

For example, the processing described herein with reference to the flowcharts and the sequence diagrams does not necessarily have to be executed in the illustrated order. Some processing steps may be executed in parallel. In addition, additional processing steps may also be adopted, while some of the processing steps may be omitted.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

A network management control device including:

a first information acquisition unit configured to acquire information indicating a network to which one or more wireless communication devices belong, radio access technology information, information relating to an operable frequency band, information relating to a geographical location and/or region, information relating to a duplex mode, or information relating to a transmission time interval;

a first notification unit configured to notify a communication control device of the information;

a second information acquisition unit configured to acquire a recommended operation parameter selected on the basis of the information;

a generation unit configured to generate a list including information of a wireless communication device which has a possibility of being located in a vicinity of the wireless communication device, by using the recommended operation parameter acquired by the second information acquisition unit; and

a second notification unit configured to notify the wireless communication device of the list and the recommended operation parameter.

(2)

The network management control device according to (1),

in which the first information acquisition unit acquires at least the information relating to the geographical location and/or region and the information relating to the duplex mode,

the recommended operation parameter acquired by the second notification unit includes at least information relating to a recommended duplex mode, and

the generation unit generates the list including the information of the wireless communication device which has a possibility of being located in a vicinity of the wireless communication device, by using the information relating to the recommended duplex mode.

(3)

The network management control device according to (1) or (2),

in which the information relating to the duplex mode includes at least an identifier indicating a duplex mode, and, in a case of TDD, the information relating to the duplex mode further includes one or more candidates for a frame configuration including combination of uplink and downlink.

(4)

A wireless communication device including:

a first notification unit configured to notify a network management control device of information indicating a network, radio access technology information, information relating to an operable frequency band, information relating to a geographical location and/or region, information relating to a duplex mode, or information relating to a transmission time interval;

an information acquisition unit configured to acquire a recommended operation parameter and a list including information of a wireless communication device which has a possibility of being located in a vicinity, from the network management control device;

a self-organizing unit configured to self-organize a wireless parameter on the basis of the recommended operation parameter acquired by the information acquisition unit;

an information processing unit configured to extract a wireless communication device which is located in a vicinity from the list acquired by the information acquisition unit by using the wireless parameter organized by the self-organizing unit; and

a second notification unit configured to perform signaling for constructing an interface with the wireless communication device which is located in the vicinity and which has been extracted by the information processing unit.

(5)

The wireless communication device according to (4),

in which the recommended operation parameter acquired by the information acquisition unit includes at least information relating to a recommended duplex mode, and

the self-organizing unit self-organizes a parameter relating to a duplex mode by using the information relating to the recommended duplex mode.

(6)

The wireless communication device according to (5),

in which the information relating to the duplex mode includes at least an identifier indicating a duplex mode, and, in a case of TDD, the information relating to the duplex mode further includes one or more candidates for a frame configuration including combination of uplink and downlink, and

in a case where TDD is recommended, the self-organizing unit selects one of the candidates for the frame configuration and performs self-organization such that operation based on the selected frame configuration is performed.

(7)

The wireless communication device according to (4),

in which the second notification unit performs signaling including at least information relating to an operating frequency band and information relating to a duplex mode.

(8)

A program for causing a computer to operate as:

a first information acquisition unit configured to acquire information indicating a network to which one or more wireless communication devices belong, radio access technology information, information relating to an operable frequency band, information relating to a geographical location and/or region, information relating to a duplex mode, or information relating to a transmission time interval;

a first notification unit configured to notify a communication control device of the information;

a second information acquisition unit configured to acquire a recommended operation parameter selected on the basis of the information;

a generation unit configured to generate a list including information of a wireless communication device which has a possibility of being located in a vicinity of the wireless communication device, by using the recommended operation parameter acquired by the second information acquisition unit; and

a second notification unit configured to notify the wireless communication device of the list and the recommended operation parameter.

(9)

A program for causing a computer to operate as:

a first notification unit configured to notify a network management control device of information indicating a network, radio access technology information, information relating to an operable frequency band, information relating to a geographical location and/or region, information relating to a duplex mode, or information relating to a transmission time interval;

an information acquisition unit configured to acquire a recommended operation parameter and a list including information of a wireless communication device which has a possibility of being located in a vicinity, from the network management control device;

a self-organizing unit configured to self-organize a wireless parameter on the basis of the recommended operation parameter acquired by the information acquisition unit;

an information processing unit configured to extract a wireless communication device which is located in a vicinity from the list acquired by the information acquisition unit, by using the wireless parameter organized by the self-organizing unit; and

a connmunication unit configured to perform signaling for constructing an interface with the wireless communication device which is located in the vicinity and which has been extracted by the information processing unit.

(10)

A method including:

acquiring information indicating a network to which one or more wireless communication devices belong, radio access technology information, information relating to an operable frequency band, information relating to a geographical location and/or region, information relating to a duplex mode, or information relating to a transmission time interval;

notifying a communication control device of the information;

acquiring a recommended operation parameter selected on the basis of the information;

generating a list including information of a wireless communication device which has a possibility of being located in a vicinity of the wireless communication device, by using the recommended operation parameter acquired by the second information acquisition unit; and

notifying the wireless communication device of the list and the recommended operation parameter.

(11)

A method including:

notifying a network management control device of information indicating a network, radio access technology information, information relating to an operable frequency band, information relating to a geographical location and/or region, information relating to a duplex mode, or information relating to a transmission time interval;

acquiring a recommended operation parameter and a list including information of a wireless communication device which has a possibility of being located in a vicinity, from the network management control device;

self-organizing a wireless parameter on the basis of the recommended operation parameter,

extracting a wireless communication device which is located in a vicinity from the list, by using the wireless parameter used in the self-organization; and

performing signaling for constructing an interface with the extracted wireless communication device which is located in the vicinity.

### REFERENCE SIGNS LIST

10 communication control device
20 network management control device
210 first communication unit
220 second communication unit
230 processing unit
231 first information acquisition unit
232 first notification unit
233 second information acquisition unit
234 generation unit
235 second notification unit
30 wireless communication device
310 first communication unit
320 second communication unit
330 processing unit
331 first notification unit
332 information acquisition unit
333 self-organizing unit
334 information processing unit
335 second notification unit

1. A network management control device comprising:
a first information acquisition unit configured to acquire information indicating a network to which one or more wireless communication devices belong, radio access technology information, information relating to an operable frequency band, information relating to a geographical location and/or region, information relating to a duplex mode, or information relating to a transmission time interval;
a first notification unit configured to notify a communication control device of the information:
a second information acquisition unit configured to acquire a recommended operation parameter selected on a basis of the information;
a generation unit configured to generate a list including information of a wireless communication device which has a possibility of being located in a vicinity of the wireless communication device, by using the recommended operation parameter acquired by the second information acquisition unit; and
a second notification unit configured to notify the wireless communication device of the list and the recommended operation parameter.

2. The network management control device according to claim 1,
wherein the first information acquisition unit acquires at least the information relating to the geographical location and/or region and the information relating to the duplex mode,
the recommended operation parameter acquired by the second notification unit includes at least information relating to a recommended duplex mode, and
the generation unit generates the list including the information of the wireless communication device which has a possibility of being located in a vicinity of the wireless communication device, by using the information relating to the recommended duplex mode.

3. The network management control device according to claim 1,
wherein the information relating to the duplex mode includes at least an identifier indicating a duplex mode, and, in a case of TDD, the information relating to the duplex mode further includes one or more candidates for a frame configuration including combination of uplink and downlink.

4. A wireless communication device comprising:
a first notification unit configured to notify a network management control device of information indicating a network, radio access technology information, information relating to an operable frequency band, information relating to a geographical location and/or region, information relating to a duplex mode, or information relating to a transmission time interval;
an information acquisition unit configured to acquire a recommended operation parameter and a list including information of a wireless communication device which has a possibility of being located in a vicinity, from the network management control device;
a self-organizing unit configured to self-organize a wireless parameter on a basis of the recommended operation parameter acquired by the information acquisition unit;
an information processing unit configured to extract a wireless communication device which is located in a vicinity from the list acquired by the information acquisition unit by using the wireless parameter organized by the self-organizing unit; and
a second notification unit configured to perform signaling for constructing an interface with the wireless communication device which is located in the vicinity and which has been extracted by the information processing unit.

5. The wireless communication device according to claim 4,
wherein the recommended operation parameter acquired by the information acquisition unit includes at least information relating to a recommended duplex mode, and
the self-organizing unit self-organizes a parameter relating to a duplex mode by using the information relating to the recommended duplex mode.

6. The wireless communication device according to claim 5,
wherein the information relating to the duplex mode includes at least an identifier indicating a duplex mode, and, in a case of TDD, the information relating to the duplex mode further includes one or more candidates for a frame configuration including combination of uplink and downlink, and
in a case where TDD is recommended, the self-organizing unit selects one of the candidates for the frame configuration and performs self-organization such that operation based on the selected frame configuration is performed.

7. The wireless communication device according to claim 4,
wherein the second notification unit performs signaling including at least information relating to an operating frequency band and information relating to a duplex mode.

8. A program for causing a computer to operate as:
a first information acquisition unit configured to acquire information indicating a network to which one or more wireless communication devices belong, radio access technology information, information relating to an operable frequency band, information relating to a geographical location and/or region, information relating to a duplex mode, or information relating to a transmission time interval;
a first notification unit configured to notify a communication control device of the information;
a second information acquisition unit configured to acquire a recommended operation parameter selected on a basis of the information;
a generation unit configured to generate a list including information of a wireless communication device which has a possibility of being located in a vicinity of the wireless communication device, by using the recommended operation parameter acquired by the second information acquisition unit; and
a second notification unit configured to notify the wireless communication device of the list and the recommended operation parameter.

9. A program for causing a computer to operate as:
a first notification unit configured to notify a network management control device of information indicating a network, radio access technology information, information relating to an operable frequency band, information relating to a geographical location and/or region, information relating to a duplex mode, or information relating to a transmission time interval:
an information acquisition unit configured to acquire a recommended operation parameter and a list including information of a wireless communication device which has a possibility of being located in a vicinity, from the network management control device;
a self-organizing unit configured to self-organize a wireless parameter on a basis of the recommended operation parameter acquired by the information acquisition unit;
an information processing unit configured to extract a wireless communication device which is located in a vicinity from the list acquired by the information acquisition unit, by using the wireless parameter organized by the self-organizing unit; and
a communication unit configured to perform signaling for constructing an interface with the wireless communication device which is located in the vicinity and which has been extracted by the information processing unit.

10. A method comprising:
acquiring information indicating a network to which one or more wireless communication devices belong, radio access technology information, information relating to an operable frequency band, information relating to a geographical location and/or region, information relating to a duplex mode, or information relating to a transmission time interval;
notifying a communication control device of the information;
acquiring a recommended operation parameter selected on a basis of the information:
generating a list including information of a wireless communication device which has a possibility of being located in a vicinity of the wireless communication device, by using the recommended operation parameter acquired by the second information acquisition unit; and
notifying the wireless communication device of the list and the recommended operation parameter.

11. A method comprising:
notifying a network management control device of information indicating a network, radio access technology information, information relating to an operable frequency band, information relating to a geographical location and/or region, information relating to a duplex mode, or information relating to a transmission time interval;
acquiring a recommended operation parameter and a list including information of a wireless communication device which has a possibility of being located in a vicinity, from the network management control device;
self-organizing a wireless parameter on a basis of the recommended operation parameter;
extracting a wireless communication device which is located in a vicinity from the list, by using the wireless parameter used in the self-organization; and
performing signaling for constructing an interface with the extracted wireless communication device which is located in the vicinity.
